(19) United States
(12) Patent Application Publication
(10) Pub. No.: US 2008/0008467 A1
(43) Pub. Date: Jan. 10, 2008

(54) Omni-directional surveillance network video camera

(76) Inventor: Yi-Chuan Liu, Jhonghe City (TW)

Correspondence Address: TROXELL LAW OFFICE PLLC, 5205 LEESBURG PIKE, SUITE 1404, FALLS CHURCH, VA, 22041, US

(21) Appl. No.: 11/480,940

(22) Filed: Jul. 6, 2006

(51) Int. Cl. G03B 17/00

(52) U.S. Cl. 396/427

(57) ABSTRACT

An omni-directional surveillance network video camera has a block base, a revolving base and a lens base. The revolving base is pivoted on a top of the block base. A revolving controller is mounted inside the block base and controls the revolving base to revolve relative to the block base. The revolving base includes a pair of pivoting arms and a shell sandwiched between the pivoting arms. The lens base is pivoted between the pivoting arms of the revolving base. A rotating controller is mounted inside the lens base and controls the lens base to rotate relative to the revolving base. Thus the omni-directional surveillance network video camera can be adjusted to nearly monitor all positions.

### BACKGROUND OF THE INVENTION

(a) Field of the Invention

The present invention relates to an omni-directional surveillance network video camera, and particularly to an omni-directional surveillance network video camera capable of rotating omni-directionally to capture images of all positions, thereby assuring to monitor all desired fields reliably.

(b) Description of the Prior Art

In prior art, movable surveillance video cameras mostly move simply in pan directions to capture images. At the same time, fields of view thereof in tilt directions are often preset as video cameras are mounted. Accordingly, fields of view are limited, and these video cameras cannot monitor all positions. Sometimes these video cameras may hang upside down, and points of view are made upward for capturing images of lower positions. Fields of view are relatively larger, but fields of view above a horizontal line become smaller, inversely influencing monitoring effect.

### SUMMARY OF THE INVENTION

Accordingly, an object of the present invention is to provide an omni-directional surveillance network video camera which is easily adjusted to all points of view thereby assuring monitored fields reliably.

Another object of the present invention is to provide an omni-directional surveillance network video camera capable of rotating 360 degree in pan directions.

A further object of the present invention is to provide an omni-directional surveillance network video camera capable of rotating about 120 degree in tilt directions.

The omni-directional surveillance network video camera comprises a block base, a revolving base, a lens base, a revolving controller and a rotating controller. The block base includes a support block and a bottom block covering a bottom of the support block. An annular embedding groove is defined in a top of the support block. A limiting rib is arranged in the embedding groove. A circuit board is fastened on an inner surface of the bottom block. The revolving base includes a pair of symmetrical pivoting arms and a shell sandwiched between the pivoting arms. A stepped flange is formed on a bottom of the revolving base for fitting to the embedding groove. A stopper is formed on a predetermined position of the stepped flange. Each pivoting arm forms a shaft base and two limiting tabs on an inner surface thereof for pivoting to the lens base. The lens base includes a lens cover covering lens, and casings for accommodating the lens and the lens cover therein. One casing forms a supporting shaft on a center of an outward surface thereof for movably connecting with a shaft base of the revolving base, and the other casing defines a shaft hole in a center thereof. Abutting sheets are provided on outward surfaces of the casings and at predetermined positions beside centers thereof. The revolving controller is mounted inside the block base and controls the revolving base to revolve relative to the block base. The rotating controller is mounted inside the lens base and controls the lens base to rotate relative to the revolving base.

The lens base is pivoted between the pivoting arms of the revolving base. The abutting sheets of the lens base are located between the limiting tabs. The rotating controller drives the lens base to rotate relative to the revolving base. The stepped flange of the revolving base engages with the embedding groove of the block base. The revolving base is pivoted to a top of the block base. Thus the omni-directional surveillance network video camera monitors all positions.

### BRIEF DESCRIPTION OF THE DRAWINGS

FIG. 1 is a perspective view of an omni-directional surveillance network video camera of the present invention.

FIG. 2 is another perspective view of the omni-directional surveillance network video camera of FIG. 1, wherein a front of the omni-directional surveillance network video camera is placed backward.

FIG. 3 is an exploded view of the omni-directional surveillance network video camera of FIG. 1.

FIG. 4 is a side view of the omni-directional surveillance network video camera of FIG. 1, especially showing cross section of a part of the omni-directional surveillance network video camera.

FIG. 5 is a cross-sectional view of the omni-directional surveillance network video camera.

FIG. 6 schematically shows a revolving base of the omni-directional surveillance network video camera revolving about a block base thereof.

FIG. 7 schematically shows a lens base of the omni-directional surveillance network video camera rotating about the revolving base thereof.

### DETAILED DESCRIPTION OF THE PREFERRED EMBODIMENTS

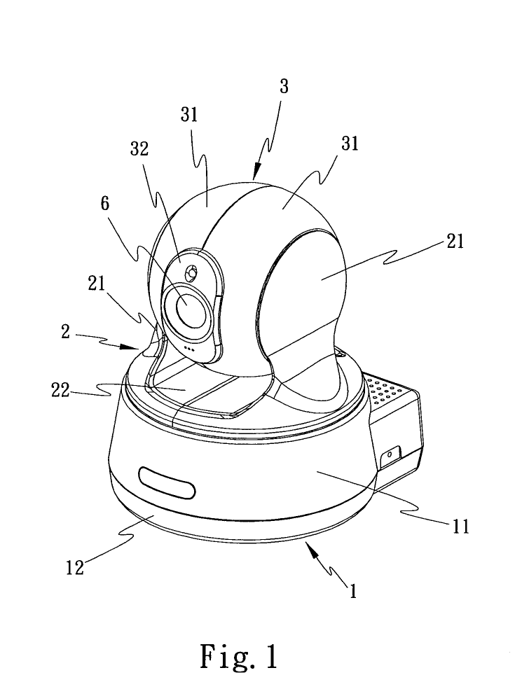

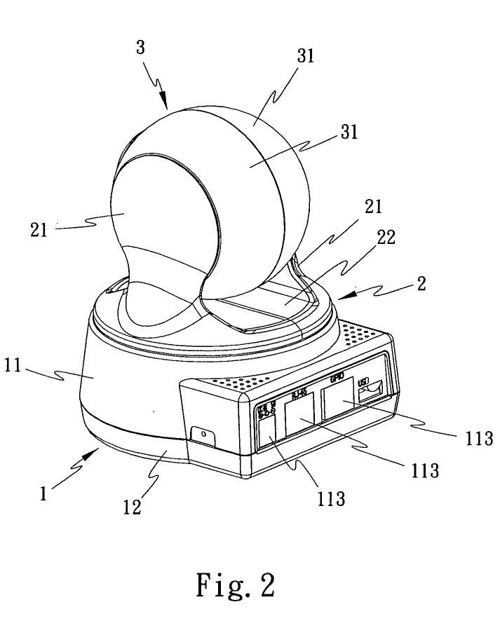

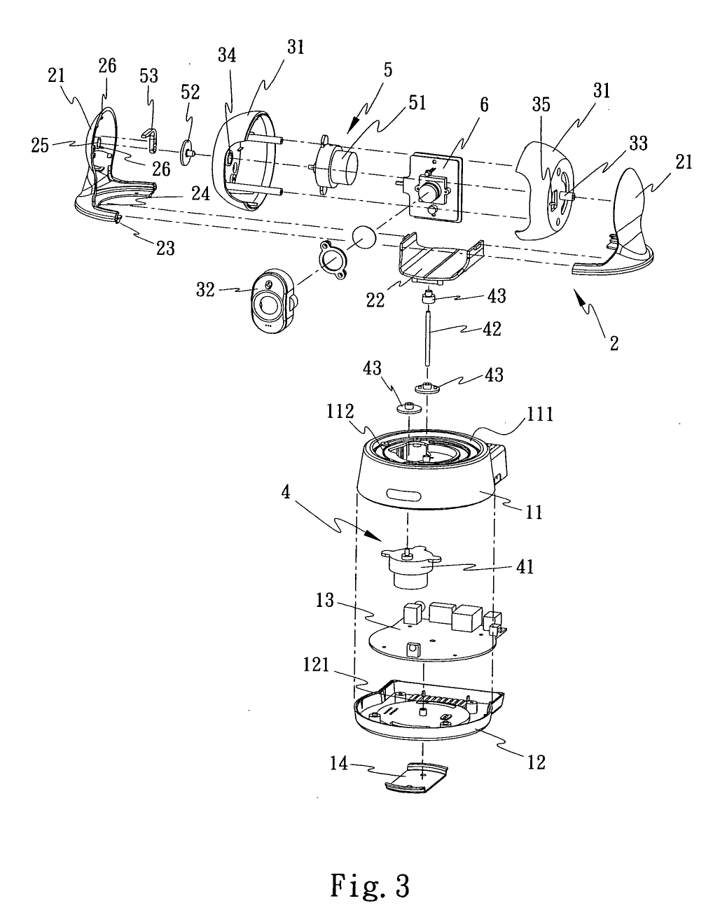

With reference to FIGS. 1 through 3, an omni-directional surveillance network video camera 1 of the present invention comprises a block base 1, a revolving base 2 and a lens base 3. A revolving controller 4 is mounted inside the block base 1, and a rotating controller 5 is mounted inside the lens base 3. The revolving controller 4 and the rotating controller 5 cooperate with each other to help lens 6 reach all positions of view.

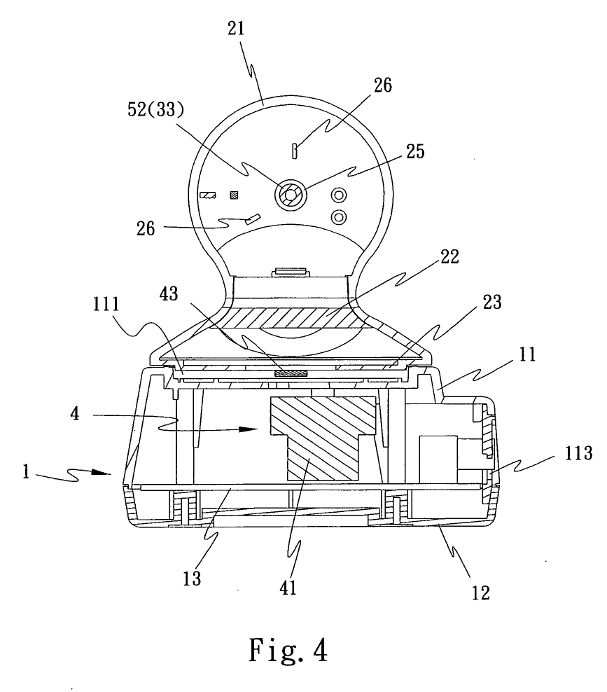

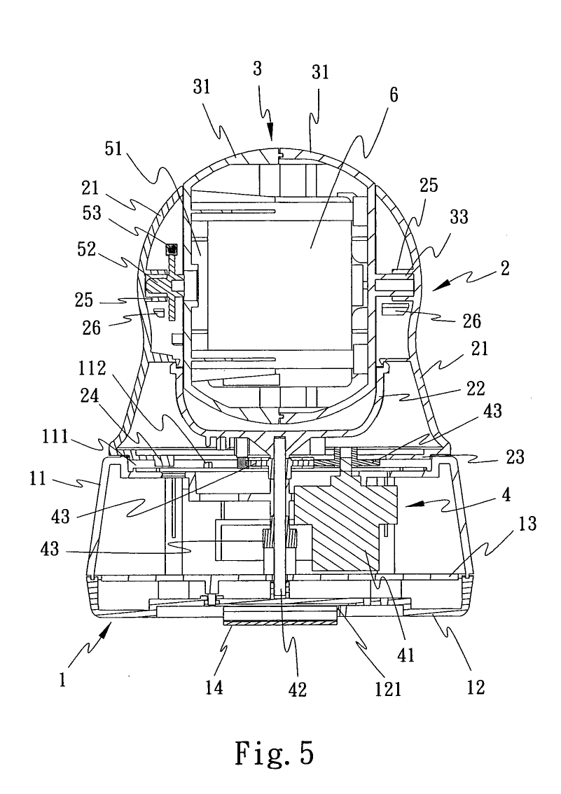

The block base 1 includes a support block 11, and a bottom block 12 covering a bottom of the support block 11. An annular embedding groove 111 is defined on a top of the support block 11, and a limiting rib 112 is arranged in the embedding groove 111. A plurality of interface sockets 113 is defined in a rear of the support block 11 for electrically connecting with various signal wires. A circuit board 13 is fastened on an inner surface of the bottom block 12. The bottom block 12 defines a locking hole 121 in a predetermined position for locking a hanging sheet 14. The revolving base 2 has a pair of substantially L-shaped pivoting arms 21 symmetrical to each other, and a U-shaped shell 22 sandwiched between the pivoting arms 21. The shell 22 and the pivoting arms 21 lock together to form generally a ring shape. Further referring to FIGS. 4 and 5, a stepped flange 23 is formed on a bottom of the revolving base 2 for fitting to the embedding groove 111. A stopper 24 is formed on a predetermined position of a surface of the stepped flange 23. Each pivoting arm 21 forms a shaft base 25 and two limiting tabs 26 on an inner surface thereof for pivoting to the lens base 3. The two limiting tabs 26 are distributed around the shaft base 25 and are spaced 120 degree from each other.

Lens 6 is mounted on the lens base 3. The lens base 3 includes a lens cover 32 covering the lens 6, and casings 31 accommodating the lens 6 and the lens cover 32 therein. One casing 31 forms a supporting shaft 33 on a center of an outward surface thereof for movably connecting with a shaft base 25, and the other casing 31 defines a shaft hole 34 in a center thereof. Abutting sheets 35 are provided on outward surfaces of the casings 31 and at predetermined positions beside centers thereof.

The revolving controller 4 controls the revolving base 2 to revolve with respect to the block base 1, and includes a first motor 41, a central shaft 42 and a plurality of first driving gears 43. The first motor 41 is retained inside the block base 1. The central shaft 42 stands through a center of the embedding groove 111, an end of the central shaft 42 extending beyond a top of the embedding groove 111 for pressing against the shell 22. The first driving gears 43 are assembled between the first motor 41 and the central shaft 42. The first motor 41 outputs power, and the first driving gears 43 and the central shaft 42 deliver the power to drive the revolving base 2.

The rotating controller 5 controls the lens base 3 to rotate relative to the revolving base 2, and includes a second motor 51, a second driving gear 52, a clutch 53 and a limiting switch (not labeled). The second motor 51 are transversely received in the lens base 3, and has a power output shaft (not labeled) extending through the shaft hole 34 and mounting on the second driving gear 52. A center of the second driving gear 52 is movably mounted on shaft base 25. The clutch 53 and the limiting switch are assembled on the pivoting arm 21 and cooperate with the second driving gear 52. The second motor 51 outputs power, and the second driving gear 52 and the clutch 53 deliver the power to drive the lens base 3.

Referring to FIG. 5, the lens base 3 is pivoted between the pivoting arms 21 of the revolving base 2. The abutting sheets 35 of the lens base 3 are located between the limiting tabs 26. The rotating controller 5 drives the lens base 3 to rotate relative to the revolving base 2. The stepped flange 23 of the revolving base 2 engages with the embedding groove 1 11 of the block base 1. The revolving base 2 is pivoted to a top of the block base 1. Thus, the omni-directional surveillance network video camera 1 can monitor all positions.

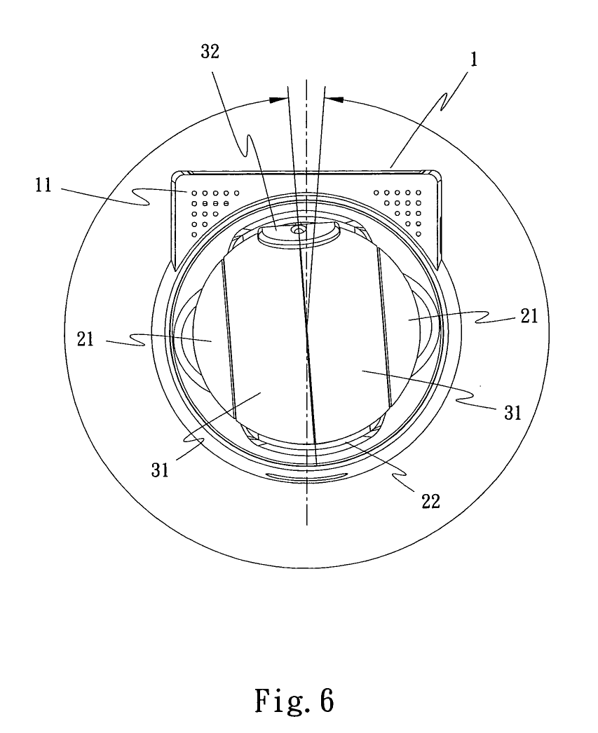

Referring to FIG. 6, the revolving controller 4 drives the revolving base 2 to revolve with respect to the block base 1. The stepped flange 23 of the revolving base 2 engages with the embedding groove 111, and the central shaft 42 supports a bottom of the revolving base 2. Therefore, the revolving base 2 revolves around a fixed point smoothly. The stopper 24 of the revolving base 2 is rotatable in the embedding groove 111, and is limited by the limiting rib 112, whereby movement course of the revolving base 2 is limited. The maximum revolving angle of the revolving base 2 is about 360 degree.

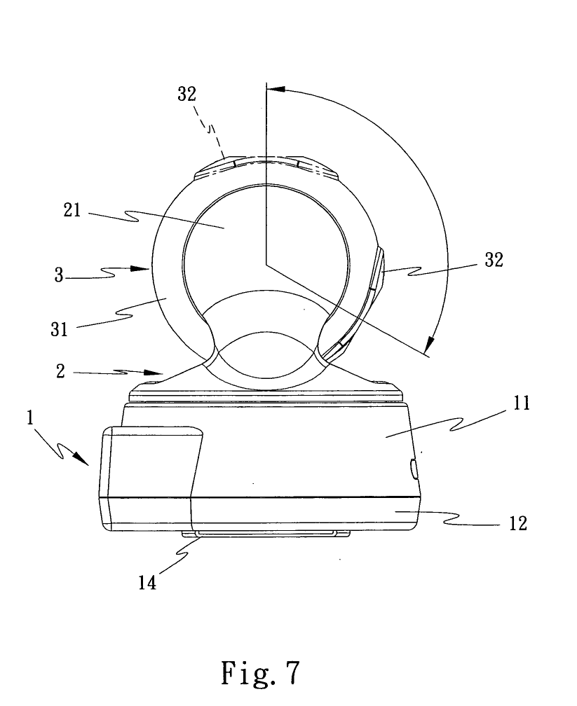

The rotating controller 5 drives the lens base 3 to rotate with respect to the revolving base 2. The abutting sheets 35 of the lens base 3 are limited by the limiting tabs 26. As an abutting sheet 35 abuts a limiting tab 26, the clutch 53 disengages from the second driving gear 52 and operates the limiting switch. The limiting switch transmits signals to stop the second motor 51. The lens base 3 rotates with respect to the revolving base 2 within a range similar to the angle between the two limiting tabs 26, namely 120 degree in this embodiment, as shown in FIG. 7.

To hang the omni-directional surveillance network video camera 1, a hanging sheet 14 locks the locking hole 121 of the block base 1. The omni-directional surveillance network video camera 1 of the present invention can be still adjusted omni-directionally in the case of hanging. Therefore all positions are monitored by the omni-directional surveillance network video camera 1.

It is understood that the invention may be embodied in other forms without departing from the spirit thereof. Thus, the present examples and embodiments are to be considered in all respects as illustrative and not restrictive, and the invention is not to be limited to the details given herein.

What is claimed is:

1. An omni-directional surveillance network video camera comprising:
a block base including a support block and a bottom block covering a bottom of the support block, an annular embedding groove being defined in a top of the support block, a limiting rib being arranged in the embedding groove, a circuit board being fastened on an inner surface of the bottom block;
a revolving base including a pair of symmetrical pivoting arms and a shell sandwiched between the pivoting arms, a stepped flange being formed on a bottom of the revolving base for fitting to the embedding groove, a stopper being formed on a predetermined position of the stepped flange, each pivoting arm forming a shaft base and two limiting tabs on an inner surface thereof for pivoting to the lens base;
a lens base including a lens cover covering the lens, and casings for accommodating the lens and the lens cover therein, one casing forming a supporting shaft on a center of an outward surface thereof for movably connecting with a shaft base of the revolving base, the other casing defining a shaft hole in a center thereof, abutting sheets being provided on outward surfaces of the casings and at predetermined positions beside centers thereof;
a revolving controller being mounted inside the block base and controlling the revolving base to revolve relative to the block base; and
a rotating controller being mounted inside the lens base and controlling the lens base to rotate relative to the revolving base,
wherein the lens base is pivoted between the pivoting arms of the revolving base, the abutting sheets of the lens base are located between the limiting tabs, the rotating controller drives the lens base to rotate relative to the revolving base, the stepped flange of the revolving base engages with the embedding groove of the block base, and the revolving base is pivoted to a top of the block base, whereby the omni-directional surveillance network video camera monitors all positions.

2. The omni-directional surveillance network video camera as claimed in claim 1, wherein the bottom block defines a locking hole in a predetermined position thereon for locking a hanging sheet.

3. The omni-directional surveillance network video camera as claimed in claim 1, wherein a plurality of interface sockets is defined in a rear of the support block for electrically connecting with various signal wires.

4. The omni-directional surveillance network video camera as claimed in claim 1, wherein the limiting tabs are distributed around the shaft base and are spaced 120 degree from each other.

5. The omni-directional surveillance network video camera as claimed in claim 1, wherein the revolving controller includes a first motor retained inside the block base, a central shaft standing through a center of the embedding groove, and a plurality of first driving gears between the first motor and the central shaft, the central shaft extending beyond a top of the embedding groove for pressing against the shell.

6. The omni-directional surveillance network video camera as claimed in claim 1, the rotating controller includes a second motor transversely received in the lens base, a second driving gear, a clutch and a limiting switch, a power output shaft of the second motor extending through the shaft hole and mounting on the second driving gear, a center of the second driving gear being movably mounted on shaft base, the clutch and the limiting switch being assembled on the pivoting arm and cooperating with the second driving gear.
